(19) United States
(12) Patent Application Publication
(10) Pub. No.: US 2008/0275966 A1
(43) Pub. Date: Nov. 6, 2008

(54) METHODS AND APPARATUS FOR PROVIDER-MANAGED CONTENT DELIVERY

(76) Inventor: Allan S. MacKinnon, Boston, MA (US)

Correspondence Address: GOODWIN PROCTER LLP;PATENT ADMINISTRATOR, EXCHANGE PLACE, BOSTON, MA, 02109-2881, US

(21) Appl. No.: 12/047,734

(22) Filed: Mar. 13, 2008

Related U.S. Application Data
(60) Provisional application No. 60/906,737, filed on Mar. 13, 2007.

(51) Int. Cl. G06F 15/173

(52) U.S. Cl. 709/219

(57) ABSTRACT

Methods and apparatus for the simple, managed delivery of content to communication devices over a wireless network. The interoperation of a client component and a server, either a gateway server or a hosted server, allows for the delivery of content to wireless communication devices in a “push” fashion, i.e., independent of the actions of the end user, in contrast to traditional “pull” media, where an end user is required to request desired content, such as a webpage. Delivery criteria allow for the conditional delivery of content to end users, and access criteria control which content providers communicate with which groups of end users.

### CROSS-REFERENCE TO RELATED APPLICATIONS

This application claims the benefit of U.S. Provisional Application No. 60/906,737, filed on Mar. 13, 2007, which is hereby incorporated by reference as if set forth in its entirety herein.

### FIELD OF THE INVENTION

The present invention relates generally to systems and methods for provider-managed content delivery, and more specifically to systems and methods allowing content providers to deliver content to various groups of users.

### BACKGROUND OF THE INVENTION

Early attempts to provide communication devices, like cell phones or personal digital assistants (PDAs), with the ability to wirelessly access content utilized variants of popular Internet standards that were specifically designed for the limited processing capabilities, memories, and displays of these devices. Two examples of these attempts include Wireless Application Protocol (WAP) and i-mode, both of which are wireless data protocols that attempt to provide wireless communication devices with functionality similar to a web browser.

While i-mode has enjoyed success in Japan, WAP has been for the most part a commercial failure, slowing the development of wireless access to the Internet. However, intervening improvements in processing capabilities, memories, and displays have made wireless communication devices more suited to Internet access and, generally speaking, the wireless delivery of content to communication devices.

Given these improvements in wireless communication devices, and despite the limitations of current wireless networks with respect to data transmission, mobile network operators (MNOs), advertisers, and content providers are showing increased interest in delivering content wirelessly to communication devices like cellphones and PDAs.

Accordingly, there is a need for methods and apparatus that allow for the simple, managed delivery of content to communication devices over a wireless network.

### SUMMARY OF THE INVENTION

Embodiments of the present invention provide methods and apparatus for the simple, managed delivery of content to communication devices over a wireless network. The interoperation of a client component and a server, either a gateway server or a hosted server, allows for the delivery of content to wireless communication devices in a “push” fashion, i.e., independent of the actions of the end user, in contrast to traditional “pull” media, where an end user is required to request desired content, such as a webpage.

A first embodiment includes a component installed on a client device and a server hosted by a content provider. The component on the client device, such as a mobile communication device, typically includes functionality for the delivery of graphics, a processor for application commands, and a database. The hosted server allows for a content provider to specify content for delivery to a user of the client device, as well as criteria to control the delivery of that content.

A second embodiment includes a component installed on a client device and a gateway server. The component on the client device, such as a mobile communication device, typically includes functionality for the delivery of graphics, a processor for application commands, and a database. The gateway server exposes an interface that may be accessed by a content provider to specify content for delivery to a user of the client device, as well as criteria to control the delivery of the content. The utilization of a gateway server allows multiple content providers to reach the same audience of end users interacting with the gateway server. Such a gateway server may be hosted by, for example, the MNO for the end users.

In one aspect, embodiments of the present invention provide a method for provider-controlled content delivery. The method includes providing a gateway server; receiving from a first content provider. delivery criteria at the gateway server to control the delivery of content to an end user; receiving from the first content provider, content at the gateway server for conditional delivery to an end user based on the received delivery criteria; and receiving access criteria specifying which of a plurality of content providers is able to communicate with a subset of a plurality of end users associated with the first content provider.

In one embodiment, the access criteria are received from the first content provider. In another embodiment, the subset of the plurality of end users consists of a single end user. In this embodiment, the access criteria may be received from the single end user. In still another embodiment, the method further includes receiving access criteria specifying which of a plurality of content providers is able to communicate with a metagroup consisting of a plurality of end users associated with a plurality of content providers. These access criteria may be received, for example, from a gateway server operator or a content provider.

In another aspect, embodiments of the present invention provide a gateway server for provider-controlled content delivery. The server includes a first receiver for receiving delivery criteria at the gateway server to control the delivery of content to an end user, a database for storing content at the gateway server for conditional delivery to an end user based on the received delivery criteria, and a second receiver for receiving access criteria specifying which of a plurality of content providers is able to communicate with the end user. In one embodiment, the first receiver and the second receiver are the same receiver.

In still another aspect, embodiments of the present invention provide a computer-readable memory having embodied thereon computer-executable instructions for provider-controlled content delivery. The memory includes computer-executable instructions for providing a gateway server, computer-executable instructions for receiving delivery criteria at the gateway server to control the delivery of content to an end user, computer-executable instructions for receiving content at the gateway server for conditional delivery to an end user based on the received delivery criteria, and computer-executable instructions for receiving access criteria specifying which of a plurality of content providers is able to communicate with a subset of a plurality of end users. In one embodiment, the memory further includes computer-executable instructions for receiving access criteria specifying which of a plurality of content providers is able to communicate with a metagroup consisting of a plurality of end users associated with a plurality of content providers.

Further embodiments also provide programmers with tools to develop applications for execution on embodiments of the present invention.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 is a block diagram illustrating the operation of a gateway server managed by a content provider and interacting with a plurality of client devices; and

FIG. 2 is a block diagram illustrating the operation of a gateway server interacting with a plurality of content providers and a plurality of client devices.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

Embodiments of the present invention allow providers to deliver their content to users of mobile communication devices. Certain embodiments allow the content providers to manage this delivery directly, for example, by hosting a server for the delivery of content. Other embodiments allow the delivery to be managed by a third party, such as an MNO or a services provider.

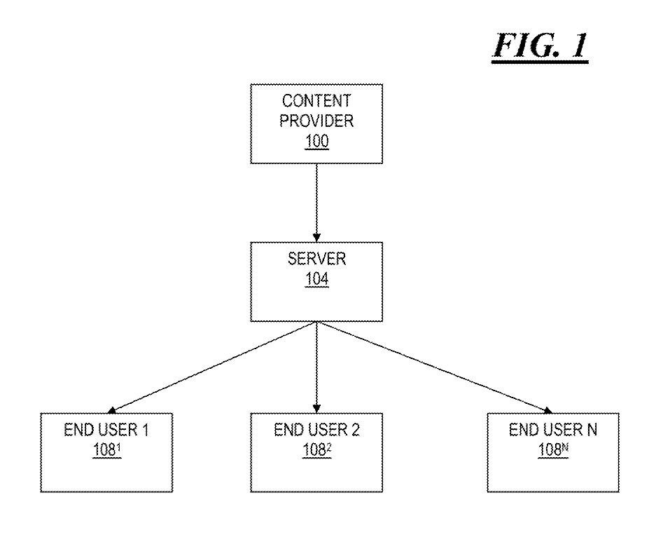

With reference to FIG. 1, a content provider 100 utilizes a server 104 to interact with at least one end user 108. The content provider 100 loads content, e.g., videos, banner advertisements, text, music, etc., onto the server 104 and then specifies metadata associated with the content. Such metadata includes, but is not limited to, information describing the content or conditions that specify the time, place, and manner of the content's provision to an end user 108. For example, the metadata may specify that it is suited to be played for end users 108 in a particular location, or at a particular time of day. The specification of metadata coupled with the ability to deliver content based on data explicitly provided by an end user 108 or implicitly provided data, as discussed below, allows for the grouping and characterization of users based on demographic data. In one embodiment, the interface exposed by the server 104 to the content provider 100 is implemented using hypertext markup language, making it suitable for operation using a standard web browser.

In one embodiment, the server 104 includes rights management mechanisms, such as an access control list (ACL). Rights management allows control over which users view or execute each application, tracking of which users do what and when, the identification of the IP network hosting the client device, the identification of the client device itself, and other user-specific privileges. This enables fine-grained control and analysis of user behavior and actions, allowing for more flexible partnering and business models. Any or all of these privileges may be revoked on a privilege-by-privilege and a user-by-user basis.

In still another embodiment, the server 104 includes mechanisms for traffic management and shaping. Utilizing these mechanisms, the entity operating the server 104 can, for example, provide free service to its own users or a third party's users, provided that the service in the aggregate consumes no more than a certain pre-negotiated level of bandwidth. Service in excess would either be throttled or charged to the third party.

The end user 108 operates a mobile communication device, such as a laptop, personal digital assistant, or a cell phone, to access networked information generally and the server 104 specifically. In one embodiment, the mobile communication device is equipped with client software that provides functionality to facilitate the delivery of content to the device from the server 104. Such functionality may include, but is not limited to, functionality for the delivery of graphics, a processor for application commands, and a database for storing information.

In one embodiment, the client software maintains a communications session with the server 104, allowing for time-based and contextual measures of application use. Session-based communications allow the monitoring of the user's activities and use patterns, which in turn allows for further targeting of advertising.

As the end user 108 operates the mobile communication device, the user 108 will explicitly pass information over a network connection to server 104. This explicitly-passed information may include, for example, uniform resource locators, keywords, IP addresses, or key presses generally. The end user 108 or the mobile communication device itself may also implicitly provide the server 104 with information, such as the location of the user 108 or device, or the time of day. The information is implicitly provided in that the end user 108 takes no action that explicitly prompts the transmission of the information to the server 104.

Upon receiving the explicitly-provided or implicitly-provided information, the server 104 compares the received information against the conditions controlling the provision of one or more pieces of content to an end user 108. If any or all of the received information matches one of the conditions, then the server 104 provides the associated piece of content to the end user 108 by way of the end user's 108 wireless communication device. In other embodiments, the delivery of content to the end user's 108 wireless communication device is either requested by the device, i.e., a “pull”-type delivery model, or initiated upon receipt of a response to a polling query sent to the wireless communication device by, e.g., the server 104 or the content provider 100.

In one embodiment, this described interaction between the server 104 and the wireless communication device allows for the delivery of sponsored content in juxtaposition with content explicitly requested by the end user 108. This allows the migration and implementation of business models utilizing sponsored advertising to the wireless context. Previous attempts to transition these business models have met with frustration, as the end user 108 in the wireless context typically pays for the delivery of content, sponsored or otherwise, to a wireless communication device, and end users 108 are not typically interested in paying for content that they have not specifically requested.

Accordingly, by utilizing the server 104 a content provider 100, such as an advertiser or an MNO, can define particular feeds of interest, e.g., sports scores, advertisements, for users 108 of a mobile communication device. Coupling appropriately-defined feeds with data concerning the mobile communication device or the user 108 allows for targeted advertisements, such as geolocated or contextual advertisements. Placing advertisements and content in separate feeds allows for the system to deliver advertisements in a true “push” fashion, i.e., independent of the actions of the user 108 of the mobile communication device.

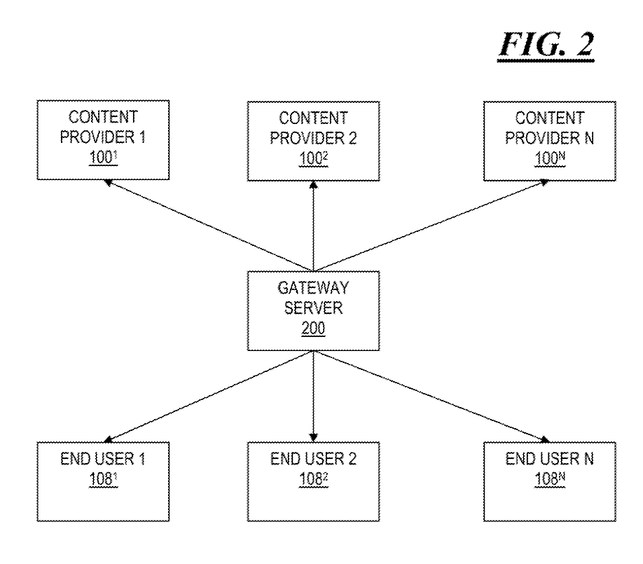

Referring to FIG. 2, in another embodiment the present invention utilizes a gateway server 200 hosted by a third party such as an MNO or a network service provider. The gateway server 200 supports connections from multiple content providers 100 for reaching end users 108 interacting with the gateway server 200.

In operation, each content provider 100 utilizes the gateway server 200 to interact with at least one end user 108. Each content provider 100 loads the server 200 with content, e.g., videos, banner advertisements, text, music, etc., and then specifies metadata associated with their provided content. Such metadata includes, but is not limited to, information describing the content or conditions that specify the time, place, and manner of the content's provision to an end user 108. For example, the metadata may specify that it is suited to be played for end users 108 in a particular location, or at a particular time of day. In one embodiment, the interface exposed by the server 200 to each content provider 100 is implemented using hypertext markup language, making it suitable for operation using a standard web browser.

In certain embodiments utilizing a gateway server, the content provider 100 utilizes the gateway server 200 in such a way as to exercise exclusive control over the content that it provides to end users 100. For example, the content provider 100 may enable or disable the provision of certain content or certain aggregations of content at various levels of user granuality: per user, per group of users, per mobile communication device, etc. The specification of metadata coupled with the ability to deliver content based on data explicitly provided by an end user 108 or implicitly provided data allows for the grouping and characterization of users based on demographic data.

In other embodiments, the gateway server 200 also includes functionality that allows a content provider 100 to maintain some degree of exclusivity with respect to that content provider's 100 end users 108. For example, it may allow a content provider 100 to configure the gateway server 200 such that the particular content provider 100 is the exclusive provider of, e.g., sports scores, to those end users 108 that interact with the gateway server 200 at the content provider's 100 behest or those end users 108 that register with the gateway server 200 due to a preexisting relationship with the content provider 100. The gateway server 200 may itself include override functionality that lets certain content providers 100 or the operator of the gateway server 200 to provide content to certain end users despite the exclusivity provisions set by a particular content provider 100. This latter functionality allows for the appropriate implementation of, e.g., contractual restrictions specifying restrictions on content delivery and user interaction.

The end user 108 interacts with the gateway server 200 by operating a mobile communication device to access networked information generally, and the gateway server 200 specifically. In a typical embodiment the mobile communication device is equipped with client software that provides functionality that facilitates the delivery of content to the device from the gateway server 200. Such functionality may include, but is not limited to, functionality for the delivery of graphics, a processor for application commands, and a database for storing information.

As the end user 108 operates the mobile communication device, the user 108 explicitly passes information to gateway server 200. This explicitly-passed information may include, for example, uniform resource locators, keywords, IP addresses, or key presses generally. The end user 108 or the mobile communication device itself may also implicitly provide the gateway server 200 with information, such as the location of the user 108 or device, or the time of day. The information is implicitly provided in that the end user 108 takes no action that explicitly prompts the transmission of the information to the gateway server 200.

Upon receiving the explicitly-provided or implicitly-provided information, the gateway server 200 compares the received information against the conditions controlling the provision of one or more pieces of content to an end user 108. If any or all of the received information matches in whole or in part one of the conditions, then the gateway server 200 provides the associated piece of content to the end user 108 by way of the end user's 108 wireless communication device. In other embodiments, the delivery of content to the end user's 108 wireless communication device is either requested by the device, i.e., a “pull”-type delivery model, or initiated upon receipt of a response to a polling query sent to the wireless communication device by, e.g., the gateway server 200 or a content provider 100.

This manner of operation between the gateway server 200 and the end user 108 through a wireless communication device also enables business models involving sponsored advertising in a wireless context. The utilization of a gateway server 200 allows for an intermediary to provide sponsored advertising business models to multiple content providers and relieves each content provider of the burden of developing and maintaining its own server 200 for communication with end users.

Accordingly, by utilizing the gateway server 200, a content provider 100, such as an advertiser or an MNO, can define particular feeds of interest, e.g., sports scores, advertisements, for users 108 of a mobile communication device. Coupling appropriately-defined feeds with data concerning the mobile communication device or the user 108 allows for targeted advertisements, such as geolocated or contextual advertisements. Placing advertisements and content in separate feeds allows for the system to deliver advertisements in a true “push” fashion, i.e., independent of the actions of the user 108 of the mobile communication device.

Those embodiments of the present invention that provider content providers 100 with some measure of exclusivity with respect to particular end users 108 (or groups of end users 108) also enable business models that treat the operator of the gateway server 200 as a “gatekeeper,” permitting the operator to charge a fee for facilitating communications between content providers 100 and their affiliated end users 108 while allaying potential concerns from content providers 100 that a gateway server 200 servicing multiple content providers 100 could be utilized to fracture or convert a particular content provider's 100 user base. These technological measures supplement and complement contractual and financial arrangements that would ensure exclusive access to particular users or groups of users. A content provider 100 may, for example, be allowed to veto provision of certain feeds to an end user 108 who cancels his subscription with the content provider, although the gateway-server operator may retain the prerogative to continue to provide other feeds over which the content provider has no control, reflecting a balance between the content provider's control over subscribers and the server operator's interest in maintaining established end-user relationships.

It will therefore be seen that the foregoing represents a highly advantageous approach to provider-managed content delivery. The terms and expressions employed herein are used as terms of description and not of limitation and there is no intention, in the use of such terms and expressions, of excluding any equivalents of the features shown and described or portions thereof, but it is recognized that various modifications are possible within the scope of the invention claimed.

Therefore, it must be expressly understood that the illustrated embodiments have been shown only for the purposes of example and should not be taken as limiting the invention, which is defined by the following claims. The following claims are thus to be read as not only literally including what is set forth by the claims but also to include all equivalents that are insubstantially different, even though not identical in other respects to what is shown and described in the above illustrations.

What is claimed is:

1. A method for provider-controlled content delivery, the method comprising:
providing a gateway server;
receiving from a first content provider, delivery criteria at the gateway server to control the delivery of content to an end user;
receiving from the first content provider, content at the gateway server for conditional delivery to an end user based on the received delivery criteria; and
receiving access criteria specifying which of a plurality of content providers is able to communicate with a subset of a plurality of end users associated with the first content provider.

2. The method of claim 1 wherein the access criteria are received from the first content provider.

3. The method of claim 1 wherein the subset of the plurality of end users consists of a single end user.

4. The method of claim 3 wherein the access criteria are received from the single end user.

5. The method of claim 1 further comprising receiving access criteria specifying which of a plurality of content providers is able to communicate with a metagroup consisting of a plurality of end users associated with a plurality of content providers.

6. The method of claim 5 wherein the access criteria are received from the gateway server operator.

7. The method of claim 5 wherein the access criteria are received from a content provider.

8. A gateway server for provider-controlled content delivery, the server comprising:
a first receiver for receiving delivery criteria at the gateway server to control the delivery of content to an end user;
a database for storing content at the gateway server for conditional delivery to an end user based on the received delivery criteria; and
a second receiver for receiving access criteria specifying which of a plurality of content providers is able to communicate with the end user.

9. The gateway server of claim 8 wherein the first receiver and the second receiver are the same receiver.

10. A computer-readable memory having embodied thereon computer-executable instructions for provider-controlled content delivery, the memory comprising:
computer-executable instructions for providing a gateway server;
computer-executable instructions for receiving delivery criteria at the gateway server to control the delivery of content to an end user;
computer-executable instructions for receiving content at the gateway server for conditional delivery to an end user based on the received delivery criteria; and
computer-executable instructions for receiving access criteria specifying which of a plurality of content providers is able to communicate with a subset of a plurality of end users.

11. The memory of claim 9 further comprising computer-executable instructions for receiving access criteria specifying which of a plurality of content providers is able to communicate with a metagroup consisting of a plurality of end users associated with a plurality of content providers.
